(19) United States
(12) Patent Application Publication
(10) Pub. No.: US 2002/0142935 A1
(43) Pub. Date: Oct. 3, 2002

(54) Consumer product kit, and a method of use therefor

(75) Inventors: Youssef Oubrahim, Tervuren (BE); Mushtaq Hussain Kamal, Liberty Township, OH (US); Pierre Luc Champelovier, Uccle (BE); Bradford Scott Barron, Wemmel (BE); Chris Van Den Wouwer, Deurne (BE)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Proter & Gamble Company

(21) Appl. No.: 10/000,547

(22) Filed: Oct. 24, 2001

(30) Foreign Application Priority Data
Oct. 27, 2000 (US) PCT/US00/29766

(51) Int. Cl. C11D 17/00

(52) U.S. Cl. 510/439

(57) ABSTRACT

A kit provides improved use of a consumer product by including a consumer product composition and a hand-held conductivity meter calibrated to the consumer product composition. The hand-held conductivity meter has a user-perceivable indicator which is used to indicate when a consumer product solution formed with the cleaning composition has the appropriate concentration of cleaning composition. A method of use employs the hand-held conductivity meter to measure the conductivity of a consumer product solution.

### FIELD OF THE INVENTION

The present invention relates to an improved consumer product kit and a method of use therefor.

### BACKGROUND OF THE INVENTION

Many consumer products are consumer product compositions which are intended to be dissolved or dispersed to form a consumer product solution. For example, when cleaning an item, such as a fabric item, a hard surface, etc., it is common to dissolve or disperse a cleaning composition within water to form a cleaning solution. The item will then usually be soaked in, scrubbed with, and/or cleaned with the cleaning solution. Methods for using such a consumer product have typically involved developing improved formulations, e.g., improved surfactants, builders, bleaches, etc. for the consumer product composition, and developing dosing devices such as scoops, sachets, etc. for the consumer product.

The effectiveness of the consumer product is typically dependent upon the concentration of the consumer product composition when dissolved, or dispersed in the consumer product solution, as well as other factors. For example, a cleaning composition, is dependent upon a variety of factors such as the type of soil to be removed, the substrate to be cleaned, the surfactant(s) and additives in the cleaning composition, and the concentration of the cleaning composition. Dosing devices provide a measurement which is intended to instruct the consumer as to how much consumer product composition should be used, but these devices may provide sub-optimum results for a variety of reasons. For example, in many locales, the washing basins, and/or washing containers where the washing solution is formed may not be of a standard size. For example, a washing basin for laundry purposes for one family may hold 10 liters of water, while another washing basin for the neighboring family may hold 15 liters. Furthermore, often a consumer does not know exactly how much water a washing basin holds, or the consumer may add a different amount of water to the same washbasin, each time. Thus, determining the correct and/or accurate amount of laundry composition which provides optimum results to launder the clothes may be very difficult, or at the least, may require excessive trial and error, by each consumer.

While dosing devices such as integrated conductivity sensing and dispensing devices for washing machines are known, these are typically limited to use in automatic and/or industrial laundering machines. For regular consumer products, such as those used in the hand-wash context and the non-automatic washing machine context, such devices have been limited to the manufacturer's recommendations printed upon the cleaning composition's container, and the use of a scoop, sachet, etc. While these appliances and/or methods usually provide a good, general method for determining the correct dosing, the consumer will typically individually adjust the cleaning composition level according to their own experience ‘and/or by following other peoples’ recommendations.

In fact, it has now been found that certain consumers regularly and significantly under-dose a consumer product composition, such as a laundry detergent composition, by from about 20% to about 50%. In such cases, the level of consumer product composition present may not be sufficient to provide optimum results. In other cases, it has now been found that certain consumers may significantly over-dose a cleaning composition by adding too much cleaning composition to the cleaning solution. This is especially true in cases where highly-soiled items are washed. In such cases, while cleaning may be improved up to a point by adding excess cleaning composition, the consumer may not getting the best possible value, as they may be adding an excessive amount of cleaning composition. Thus, the consumer may be wasting the over-dosed portion of the cleaning composition. Accordingly, this shows that consumers may not be receiving the best possible results and/or best possible values from the cleaning composition.

Accordingly, the need exists for an improved consumer product kit which provides a more accurate recommendation for the optimum amount of consumer product to be used. The need also exists for a method of using a consumer product kit to better ensure that the optimum amount of consumer product is used.

### SUMMARY OF THE INVENTION

The present invention relates to an improved consumer product kit which includes a consumer product composition and a hand-held conductivity meter calibrated to the consumer product composition. The hand-held conductivity meter has a user-perceivable indicator which is used to indicate when a consumer product solution formed with the consumer product composition has the appropriate concentration of the consumer product composition.

The present invention also relates to a method for measuring the conductivity of a consumer product solution which includes the steps of providing a hand-held conductivity meter calibrated to a consumer product composition; adding the consumer product composition to water to form a consumer product solution; measuring the conductivity of the consumer product solution with the hand-held conductivity meter; and reading the user-perceivable indicator. The hand-held conductivity meter has a user-perceivable indicator which is used to indicate when the consumer product solution has the appropriate conductivity, and therefore, the appropriate concentration of consumer product composition.

It has now been found that a hand-held conductivity meter may provide an accurate, convenient, and/or beneficial measurement of the consumer product composition level in a consumer product solution, especially for a cleaning composition in a hand-wash context and/or a non-automatic washing machine context. Such a measurement informs the consumer when more consumer product composition should be added, and/or whether too much consumer product composition has been added. This can significantly increase consumer satisfaction with the consumer product in the case where the consumer has otherwise under-dosed the consumer product composition, and/or increase consumer product composition mileage and cost-effectiveness in cases where the consumer has over-dosed the consumer product composition.

These and other features, aspects, advantages, and variations of the present invention, and the embodiments described herein, will become evident to those skilled in the art from a reading of the present disclosure with the appended claims, and are covered within the scope of these claims.

### BRIEF DESCRIPTION OF THE FIGURES

While the specification concludes with claims particularly pointing out and distinctly claiming the invention, it is believed that the invention will be better understood from the following description of the accompanying figures in which:

FIG. 1 is a perspective view of a preferred embodiment of a hand-held conductivity meter;

FIG. 2 is a schematic circuit diagram of a preferred embodiment of a hand-held conductivity meter;

FIG. 3 is a schematic circuit diagram of a preferred embodiment of a disposable hand-held conductivity meter;

FIG. 4a is a front view of a preferred embodiment of a hand-held conductivity meter when in use

FIG. 4b is a front view of the hand-held conductivity meter of FIG. 4a, except when not in use; and

FIG. 5 is a front view of a preferred embodiment of a hand-held conductivity meter when in use.

### DETAILED DESCRIPTION OF THE INVENTION

All percentages, ratios and proportions herein are by weight, unless otherwise specified. All temperatures are in degrees Celsius (° C. ) unless otherwise specified. All documents cited are incorporated herein by reference in their entireties. Citation of any reference is not an admission regarding any determination as to its availability as prior art to the claimed invention. The figures herein are not necessarily drawn to scale.

As used herein, the term “disposable” describes an item that may be disposed of as any other consumer product, preferably in an environmentally-acceptable and safe manner such as via recycling. This term also encompasses an item which is of such low cost to the consumer, or of such a limited in-use life-span (e.g., <1 week) that it is cost-effective for the user to dispose of the item, rather than fixing, recharging, and/or repairing it.

As used herein, the term “durable” describes an item that may be used many times, recharged, repaired, and/or used over extended period of time (e.g., >1 month). This term also encompasses an item which is cost-effective for the user to fix, recharge, and/or repair.

As used herein, the term “hand-held” describes an item which is easily and conveniently handled in an average-sized human hand. Preferably, this term indicates that the item has an ergonomic size, weight, and shape which makes it easy to comfortably hold in the hand.

As used herein, the term “non-automatic washing machine” describes a class of washing machines which do not provide all of the features of a fully-automatic washing machine. In effect, a non-automatic washing machine requires some human interaction in addition to adding the cleaning composition and clothes to the washing machine. For example, a non-automatic washing machine may have a basin for holding a combination of washing solution and fabrics, and for agitating this combination, but it may require manual filling and emptying of water and/or the washing solution. Or, a non-automatic washing machine may merely drain water from the basin, but may not “spin-dry” the clothes; thus, the clothes are typically still wrung out by hand before being hung up to dry. Another type of non-automatic washing machine has a basin for holding the wash solution (for manual washing) and a second basin for spinning. However, the user has to manually remove the clothes from washing basin and place them into spinning basin.

As used herein, the term “over-dose” means a situation where too much consumer product composition (as compared to the manufacturer's recommended dosage) has been added to form the consumer product solution. This typically results in either a minimal incremental cleaning benefit, and in extreme cases, in wastage of the consumer product composition. Such cases decrease consumer product composition mileage, and undesirably raise the costs for the consumer.

As used herein, the term “under-dose” means a situation where too little consumer product composition (as compared to the manufacturer's recommended dosage) has been added to form the consumer product solution. This typically results in insufficient benefits from the consumer product, such as inefficient cleaning and/or ineffective cleaning. Such cases can be frustrating to the consumer, and decrease overall consumer satisfaction with the consumer product.

Consumer Product Composition

The consumer product composition herein may be any consumer product which is intended to be dissolved and/or dispersed in water to form a consumer product solution. The consumer product herein is typically a conditioning composition and/or a cleaning composition useful for cleaning, bleaching, etc., Specific examples of the conditioning composition useful herein include a hair conditioning composition and a fabric conditioning composition. Specific examples of the cleaning composition herein include a hard surface cleaning composition, a laundry detergent composition, a personal cleansing composition, a bleach composition, a fabric rinse composition or a combination thereof, and preferably a hard surface cleaning composition, a laundry detergent composition, or a combination thereof. Without intending to be limited by theory, it is believed that a cleaning composition may especially benefit from the kit and method herein, as they are commonly used in a hand-washing situation, and/or in situations where the consumer often adjusts the dosage of cleaning composition by hand, according to their intuition. The cleaning composition herein is typically soluble, preferably highly soluble, in water, and is typically dispersed and/or predissolved in the water prior to use for cleaning an item.

The consumer product composition useful herein is not limited in physical form, and may be aqueous or non-aqueous, and may be in a liquid, solid, paste, foam, tablet, bar, granule, gel, or any other consumer-acceptable form. A preferred consumer product composition useful herein includes an aqueous liquid cleaning composition, a granular solid cleaning composition, and a gel cleaning composition.

The hard surface cleaning composition useful herein is typically formulated for use on a surface and/or an item such as a dish, tiling, flooring, a wall, glass, etc. Preferably, the hard surface cleaning composition is a hand dishwashing composition, a floor cleaning composition, and/or a glass cleaning composition. Preferred examples of such a hard surface cleaning composition include aqueous and non-aqueous cleaning compositions such as described in, for example, U.S. Pat. No. 5,990,065 to Vinson, et al., issued on Nov. 23, 1999; WO 99/03512 A1 to Boucher and Kain, published on Jan. 28, 1999; WO 99/24539 A1 to Kasturi, et al., published May 20, 1999; WO 99/27058 A1 to Kasturi, et al., published Jun. 3, 1999; WO 99/27054 to Kasturi and Schafer, published on Jun. 3, 1999; WO 99/27053 to Kasturi, et al., published on Jun. 3, 1999; WO 99/27057 to Kasturi, et al., published on Jun. 3, 1999; WO 99/63034 to Vinson, et al., published on Dec. 9, 1999; WO 00/46331 to Clarke, et al., published Aug. 10, 2000; and EP Application No. 99/870275.7 by Clarke, et al., filed on Dec. 22, 1999.

The laundry detergent composition useful herein is typically a liquid, solid, or gel composition, preferably a solid granular laundry detergent composition, a liquid laundry detergent composition, a gel laundry detergent composition, and a combination thereof. Preferred examples of the laundry detergent composition useful herein include those described in, for example, WO 95/33044 to Vinson, et al., published on Dec. 7, 1995; WO 99/09126 to Bettiol, et al., published on Feb. 25, 1999; PCT Patent Application No. U.S. 00/00839 to Showell, et al., filed on Jan. 13, 2000; U.S. Pat. No. 5,916,862 to Morelli, et al., issued on Jun. 29, 1999; U.S. Pat. No. 5,565,145 to Watson, et al., issued on Oct. 15, 1996; U.S. Pat. No. 5,470,507 to Fredj, et al., issued on Nov. 28, 1995; U.S. Pat. No. 5,466,802 to Panadiker, et al., issued on Nov. 14, 1995; U.S. Pat. No. 5,460,752 to Fredj, et al., issued on Oct. 24, 1995; U.S. Pat. No. 5,458,810 to Fredj, et al., issued on Oct. 17, 1995; and U.S. Pat. No. 5,458,809 to Fredj, et al., issued on Oct. 17, 1995.

The personal cleansing composition useful herein may include a hand, body, and/or toilet soap and/or wipe which is formulated for mild cleaning of the human body. The personal cleansing composition thus contains a mild surfactant, typically an anionic surfactant, a moisturizing agent, and other typical ingredients. A preferred hand, body, and/or toilet soap and/or wipe useful herein is described in, for example, U.S. Pat. No. 6,028,043 to Glenn, et al., issued on Feb. 22, 2000; WO 99/57238 A1 to Gu, published on Nov. 11, 1999; WO 98/55094 A1 to Beers, et al., published on Dec. 10, 1998; European Patent Application 556 546 A2 to Widulle, et al., published on Aug. 25, 1993; European Patent Application 555 634 A2 to Widulle, et al., published on Aug. 18, 1993; U.S. Pat. No. 4,939,284 to Degenhardt, issued on Jul. 3, 1990; U.S. Pat. No. 4,847,072 to Bissett, et al., issued on Jul. 11, 1989; and U.S. Pat. No. 4,820,698 to Degenhardt, issued on Apr. 11, 1989.

The bleaching composition useful herein provides a whitening and/or a brightening effect on the fabric article, and may contain any bleach per se known in the art, either alone, or in conjunction with any bleach activators and/or bleach boosters known in the art. A preferred bleach useful herein is a halide bleach, an oxygen bleach, and a mixture thereof, more preferably an oxygen bleach. Oxygen bleaches are highly preferred as they are typically safer on fabrics, especially colored fabrics, than halide-based bleaches.

Specific, non-limiting examples of the bleaching composition useful herein include those described in U.S. Pat. No. 5,559,090 to Scialla and Cardola, issued on Sep. 24, 1996; U.S. Pat. No. 5,536,438 to Scialla, et al., issued on Jul. 16, 1996; WO 95/21122 to Rapisarda, et al., published on Aug. 10, 1995; U.S. Pat. No. 6,037,317 to Rapisarda, et al., issued on Mar. 14, 2000; WO 95/34621 to Scialla, et al., published on Dec. 21, 1995; U.S. Pat. No. 5,929,012 to Del Duca, et al., issued on Jul. 29, 1999; U.S. Pat. No. 5,910,473 to Aldano, et al., issued on Jun. 8, 1999; U.S. Pat. No. 6,001,794 to Del Duca, et al., issued on Dec. 14, 1999; WO 97/02332 to Masotti, et al., published on Jan. 23, 1997; WO 97/22407 to Bianchetti, et al., published on Jun. 26, 1997; U.S. Pat. No. 5,968,885 to Del Duca, et al., issued on Oct. 19, 1999; U.S. Pat. No. 5,641,739 to Kott and Willey, issue don Jun. 24, 1997; WO 97/47558 to Del Duca, et al., published on Dec. 18, 1997; U.S. Pat. No. 6,019,797 to Del Duca, et al., issued on Feb. 1, 2000; WO 98/11191 to Scialla, et al., published on Mar. 19, 1998; WO 98/11189 to Burns, et al., published no Mar. 19, 1998; WO 97/32962 to Del Duca, et al., published on Sep. 12, 1997; WO 98/11192 to Masotti, et al., published on Mar. 19, 1998; WO 98/18893 to Del Duca, et al., published on May 7, 1998; WO 98/ 22560 to Bertacchi, et al., published on May 28, 1998; WO 98/33879 to Del Duca, et al., published on Aug. 6, 1998; WO 99/18181 to Del Duca, et al., published on Apr. 15, 1999; WO 99/18179 to Del Duca, et al., published on Apr. 15, 1999; WO 99/18183 to Del Duca, et al., published on Apr. 15, 1999; WO 99/24540 to Del Duca, et al., published on May 20, 1999; WO 99/63033 to Del Duca, et al., published on Dec. 19, 1999; WO 00/12666 to Campestrini, et al., published on Mar. 9, 2000; and WO 00/15743 to Briatore, et al., published on Mar. 23, 2000.

The conditioning composition useful herein provides a conditioning, softening, anti-static, smoothening, etc. benefit on fibers, such as, for example, hair fibers or fabric fibers. Preferably, the conditioning composition herein is a fabric conditioning composition such as disclosed in U.S. Pat. 4,062,647 to Storm and Nirschl, issued Dec. 13, 1977; U.S. Pat. No. 4,375,416 to Crisp, et al., issued Mar. 1, 1983; U.S. Pat. No. 4,291,071 to Harris, et al., issued Sep. 22, 1981; and PCT Patent Application U.S. 99/15056 to Bryant, et al., filed on Jul. 1, 1999. In a highly preferred embodiment, the fabric conditioning composition here is a clear, transparent, or translucent fabric conditioning composition. Specific examples of which include those disclosed in U.S. Pat. No. 5,747,443 to Wahl, et al., issued May 5, 1998, and in U.S. patent application Ser. Nos. 08/621,019; 08/620,627; 08/620,767; 08/620,513; 08/621,285; 08/621,299; 08/621,298; 08/620,626; 08/620,625; 08/620,772; 08/621,281; 08/620,514; and 08/620,958, all filed Mar. 22, 1996, and all having the title “CONCENTRATED, STABLE, PREFERABLY CLEAR, FABRIC CONDITIONING COMPOSITION”.

The fabric rinse composition useful herein serves to further reduce chemical, surfactant, and/or other residues on the item to be washed. Highly preferred examples of the fabric rinse composition useful herein include those described in PCT Patent Application No. WO U.S. 00/25684 to Bettiol, et al., filed on Sep. 20, 2000; and PCT Patent Application No. WO U.S. 00/25685 to Bettiol, et al., filed on Sep. 20, 2000.

As noted above, the consumer product composition is typically dispersed, preferably dissolved in water to form a consumer product solution. The consumer product composition will typically be added to the water and then agitated to facilitate dissolution and/or dispersion. After measuring the conductivity of the consumer product solution with the hand-held conductivity meter, and adjusting the weight ratio of consumer product composition to water, as needed, to achieve an acceptable consumer product concentration, the consumer product solution is used, for example for conditioning or cleaning an item With the preferred cleaning compositions, the items to be cleaned are then typically soaked, scrubbed, sprayed, contacted, and/or washed with the cleaning solution.

Hand-Held Conductivity Meter

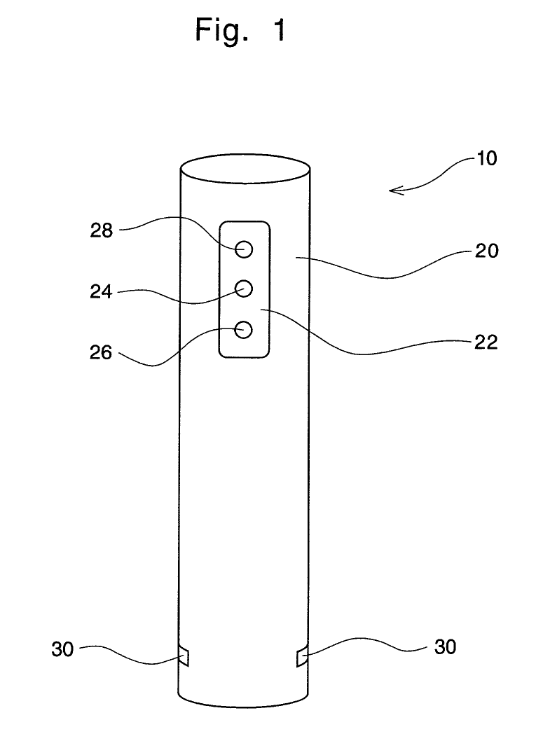

Referring to the drawings, FIG. 1 shows a hand-held conductivity meter (HHCM), 10, of the present invention, having a casing, 20. The casing may be formed of any material, especially plastic, resin, and/or a polymer, and should at least be water-resistant, and is preferably waterproof to prevent water and/or cleaning solution from contacting and damaging the components contained therein. For ease of use, the HHCM and/or the casing is preferably designed to float when dropped into water and/or the consumer product solution; more preferably the density of the HHCM is less than water and the center of gravity is such that the HHCM floats in an orientation wherein the electrodes (see FIG. 1 at 30) are in contact with the water and/or the consumer product solution.

The size, shape, weight, and other physical characteristics of the HHCM may vary without departing from the scope of the present invention. The size of the HHCM may vary considerably depending upon the desired shape of the HHCM, but at least a portion of the HHCM should be of a size which is convenient to hold in the hand. Preferably, the HHCM is from about 3 cm to about 50 cm, and more preferably from about 5 cm to about 40 cm in length. Preferably the height and width of the HHCM are independently from about 0.5 cm to about 20 cm, and more preferably from about 1 cm to about 15 cm. However, these measurements are not intended to be in any way limiting to the present invention, as it is recognized that in certain cases, the actual measurements may be outside of the above ranges. For example, where the HHCM is of a thin shape, such as a credit-card shape, the HHCM may have a preferred width of from about 0.25 mm to about 3 mm. Thus, while the preferred shape for the HHCM is a round shape, a tubular shape, a cube shape, a conical shape, and a combination thereof, the HHCM may also preferably be designed to have a pen-like or a wand-like shape, a credit-card like shape, an ergonomically-contoured shape, and a combination thereof. For ease of use and ease of holding, it is preferred that the HHCM weigh from about 1 g and about 1 kg, preferably from about 10 g to about 500 g, and more preferably from about 20 g to about 200 g. The HHCM may also be designed to be disposable, and/or durable, as desired, from a cost, convenience, and/or ease-of-production standpoint. A disposable HHCM may be preferred in cases where a low-cost HHCM is desired, while a durable HHCM may be preferred in cases where a high-quality, high-accuracy HHCM is desired. In cases where a disposable HHCM is provided, each HHCM may have a very limited working life span, for example about 1 day or less. Thus, multiple disposable HHCMs may be provided in the kit herein.

The casing, 20, contains a user-perceivable indicator, 22, which further contains an acceptable concentration indicator, 24, a low concentration indicator, 26, and a high concentration indicator, 28. The acceptable concentration indicator, 24, is a green light emitting diode (LED), while the low concentration indicator, 26, and high concentration indicator, 28, are red LEDs. The casing, 20, also contains a plurality of electrodes, 30, which come into contact with the water and/or the consumer product solution when the hand-held conductivity meter, 10, is dipped, placed, and/or immersed in the water and/or the consumer product solution.

The HHCM measures the conductivity of the consumer product solution to provide a measurement of the consumer product composition concentration in the solution. As the typical conductivity of different consumer product compositions vary significantly, the HHCM should be calibrated to the actual consumer product composition to be measured. Such calibration may be provided by information in a table, a mathematical algorithm, and/or a memory module in the HHCM. Such information may be provided at any time, for example, during the manufacturing stage of the HHCM, upon purchase of the HHCM, and/or immediately prior to use of the HHCM, as desired.

The user-perceivable indicator indicates to a user or consumer whether the consumer product solution has an acceptable conductivity. As used herein, a “user-perceivable indicator” means any indicator which is perceivable by the user and/or consumer, preferably a visual indicator, an audible indicator, or a combination thereof, such as produced by a LED, a liquid crystal display (LCD), a light, a meter, a speaker, a screen, a color indicator, etc. For cost and ease-of-use reasons, a LED, a LCD, a light, a color indicator, and a combination thereof are preferred, more preferably, a plurality of above indicators are employed to form the user-perceivable indicator herein. For example, a plurality of LEDs, a speaker and a plurality of LEDs, etc.

The color indicator may change color to indicate to the consumer the conductivity of the consumer product solution. An example of a preferred color change indicator is, for example, the condition indicator described in U.S. Pat. No. 5,596,278 to Lin, issued on Jan. 21, 1997; and the tester described in U.S. Pat. No. 5,627,472 to Ofer, et al., issued on May 6, 1997.

The user-perceivable indicator indicates to the user whether the cleaning solution has an acceptable conductivity for the consumer product composition being measured, and therefore may be an “acceptable concentration indicator” as the term is used herein. In addition to indicating whether an acceptable concentration has been attained in the consumer product solution, the user-perceivable indicator may also provide additional information, such as whether the conductivity of the consumer product solution is unacceptable (i.e., an “unacceptable concentration indicator”), too low (i.e., a “low concentration indicator ”), and/or too high (i.e., a high concentration indicator”). In a highly preferred embodiment, the user-perceivable indicator may further provide information such as whether the consumer product solution is at the appropriate concentration for specific classes of items, such as items to be cleaned, e.g., lightly-soiled items, regularly-soiled items, heavily-soiled items, and/or delicate-wash items.

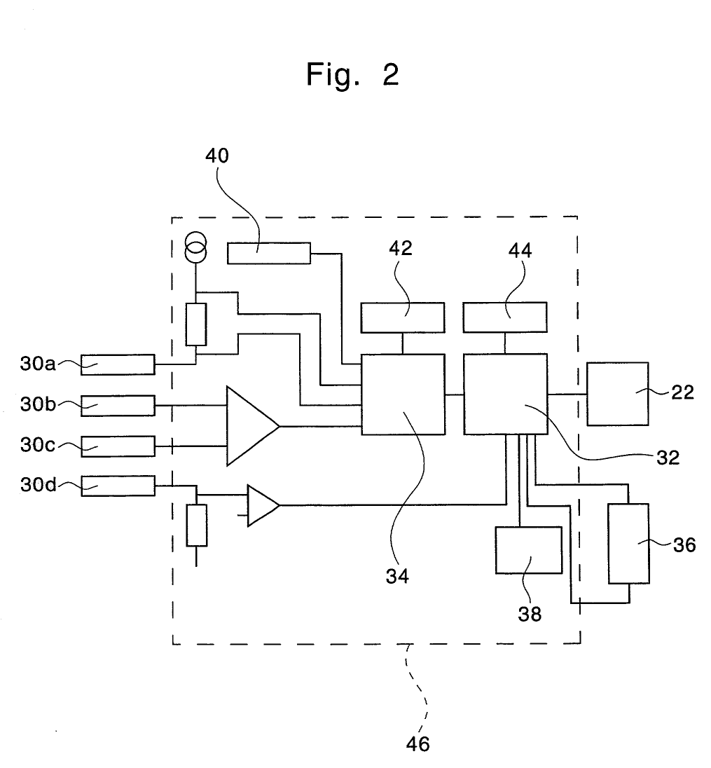

In FIG. 2, a circuit diagram of a preferred HHCM shows that a plurality of electrodes, 30a, 30b, 30c, 30d, are operatively connected to the processor, 32, via an analog to digital converter (ADC), 34. In addition, a battery, 36, memory module, 38, and a thermistor, 40, are also operatively connected to the processor, 32. The processor, 32, calculates the conductivity of the consumer product solution, based on the data received from the plurality of electrodes, 30, and one or more measurements therefrom. In addition, the processor, 32, may further adjust the conductivity measurement according to the temperature data received from the thermistor, 40, and/or the memory module, 38, and/or the electrodes, 30a and 30d. A bandgap, 42, provides a stable reference voltage, while an oscillator, 44, provides a timing function. When a conductivity measurement is completed, the processor, 32, activates the appropriate signal on the user-perceivable indicator, 22.

The battery useful herein may be any disposable, and/or rechargeable battery or other power source known in the art, preferably an alkaline battery, a nickel-cadmium battery, a nickel-metal hydride battery, a zinc-carbon battery, a silver oxide battery, a lithium battery, a water-activated battery, or a combination thereof. While a water-activated battery may be useful herein, it is typically not preferred. Multiple batteries may also be used herein. In cases where the battery is a rechargeable battery, it is highly preferred that the recharging mechanism be an induction-type recharging mechanism, typically with a convenient recharging base (not shown), as these do not require external contacts in order to recharge the battery. Such a recharging system, which is commonly used in rechargeable cordless phones and razors, is especially preferred as it avoids corrosion of external (i.e., exposed on the casing) recharging contacts, and short-circuiting caused by electricity undesirably flowing between external recharging contacts. In addition, as the HHCM is hand-held, and is preferably self-contained, a battery is highly preferred as opposed to a connector to an external power source (i.e., an AC electricity outlet). The battery useful herein may be removable, replaceable and/or permanent, as desired. In certain cases where the HHCM is a disposable HHCM, then a permanent battery is preferred. However, where the HHCM is a durable HHCM, then a rechargeable, replaceable, and/or removable battery is preferred.

The memory module may be any type of memory storage device known in the art, but should be cost-effective and energy-efficient. An example of a highly preferred memory module useful herein includes microchips, hard-wired instructions, and a combination thereof, and preferably a ROM chip, a flash-memory chip, and a combination thereof. If the HHCM is intended to be a durable HHCM, then a flash-memory chip is especially preferred, as it is energy-efficient, and yet the data contained therein may be easily updated. The memory module retrievably stores information such as, but not limited to, the acceptable conductivity range of the cleaning solution, local water hardness information, temperature adjustment factors, etc. Other useful information may also be stored in the memory module, for example, the acceptable conductivity range for lightly-soiled items, the acceptable conductivity range for highly-soiled items, the acceptable conductivity range for delicate-wash items, and a combination thereof.

As other factors, especially temperature and/or water hardness may also significantly affect the conductivity measurement, it is highly preferred that the HHCM also be calibrated to and/or take account of these factors as well. Thus, the HHCM of FIG. 2 includes a thermistor, 40, which measures the temperature of the cleaning solution and feeds this information to the processor, 32. Other temperature measuring circuits and devices are also useful herein in place of the therrnistor.

The processor, 32, receives the temperature data from the thermistor, 40, and compensates for the temperature of the cleaning solution by, for example, adjusting the measured conductivity by a corresponding temperature adjustment factor stored in the memory module, 38. Water hardness may be compensated for by calibrating the HHCM to take into account local water hardness measurements, via data stored in the memory module, or by other means. For example, the HHCM may be first used to measure the water, prior to the addition of the consumer product composition so as to establish a baseline, and then subsequently used to measure the conductivity after the consumer product solution is formed.

In FIG. 2, the HHCM has four separated electrodes, 30a, 30b, 30c, and 30d, which allow the HHCM to compensate for contamination of the electrodes caused by the accumulation of ions thereupon. Specifically, as the HHCM is used, negatively-charged ions in the consumer product solution will quickly become attracted to, and coat the positive electrode, while positively-charged ions will quickly become attracted to and coat the negative electrode. This ion coating on the electrodes can significantly increase the resistance to conductivity, and may in turn provide inaccurate conductivity measurements, if not corrected for and/or regularly removed. However, this may be compensated for by having more than two electrodes, preferably four electrodes, and by measuring the voltage across two pairs of electrodes, for example, between electrode pair 30a and 30d, and between electrode pair 30b and 30c. As this voltage measurement requires virtually no current to be drawn through the electrode pair 30b and 30c, it is therefore unaffected by the additional resistance caused by contamination, a protective coating layer (not shown), etc. To further protect the HHCM from contamination and damage to the electrodes, it is highly preferred that the electrodes be covered with a protective coating layer, such as a thin layer of plastic, lacquer, or other non-conductive and/or relatively inert material.

In FIG. 2, the processor, 32, memory module, 36, thermistor, 40, bandgap, 42, oscillator, 44, and ADC, 34, are formed as part of a single microchip, specifically an application specific integrated circuit (ASIC), 46, which includes the components bounded by dashed line 46. In the embodiment of FIG. 2, there is no power switch, and thus, the HHCM is continuously powered. When not in use, the conductivity is measured every few seconds, according to a pre-set “sleeping” rate, without using the ADC, 34, or the processor, 32. When the electrodes are dipped into water, and/or a cleaning solution, the conductivity rises above a certain “wet” threshold which is hardwired in the ASIC, 46. This in turn generates a “wake-up” signal from an electrode, 30d, to the processor, 32. At this time, the processor, 32, begins to take more accurate conductivity measurements at a faster rate, while compensating for variations caused by temperature, and/or other factors. After the conductivity measurement is made, a signal is sent to the user-perceivable interface, 22, to alert the consumer.

When the device of FIG. 2 is removed from the solution, the conductivity falls below the “wet” threshold and the frequency of the conductivity measurements return to the “sleeping” rate.

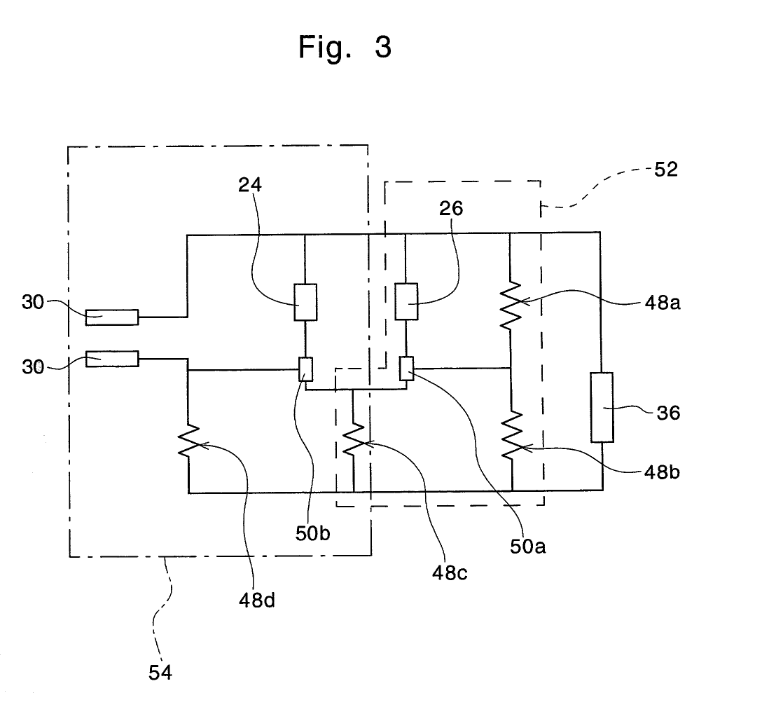

FIG. 3 shows a schematic circuit diagram of a referred embodiment of a disposable HHCM of the present invention. In FIG. 3, a battery, 36, is connected to a plurality of resistors, 48, two transistors, 50, an acceptable concentration indicator, 24, a low concentration indicator, 26, and two electrodes, 30. In the low concentration circuit, 52, a resistor, 48a, is in series with another resistor, 48b, with a transistor, 50a, connected therebetween via a shunt. A low concentration indicator, 26, is connected in parallel to the first resistor, 48a. In the acceptable concentration circuit, 54, a resistor, 48d, is connected to two electrodes, 30, with a transistor, 50b, connected therebetween via a shunt. An acceptable concentration indicator is connected in parallel to the electrodes, 30.

When the disposable HHCM of FIG. 3 is immersed in the cleaning solution, the current flows between the two electrodes, 30, to complete the acceptable concentration circuit, 54. However, the acceptable concentration circuit, 54, will only be completed if it has a lower resistance than the low concentration circuit, 52. In other words, in order to potentially complete the acceptable concentration circuit, 52, and thereby activate the acceptable concentration indicator, 24, the resistance of the cleaning solution+resistor 48d must be lower than the resistance of resistor 48a+resistor 48b. This assumes, of course, that the other resistances of the circuit paths are the same, or negligible, as compared to the above resistors and the cleaning solution.

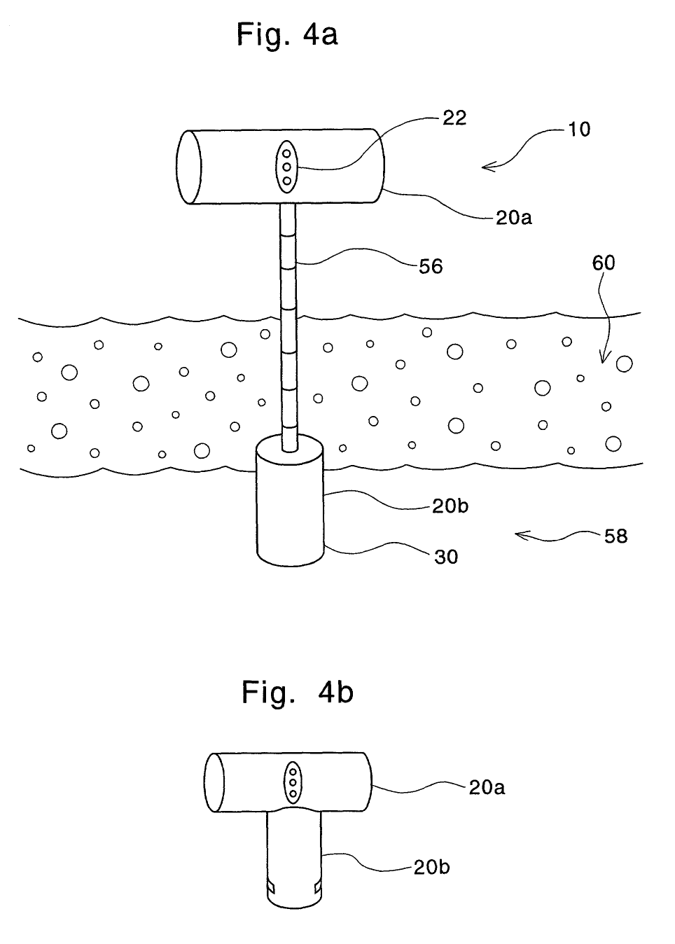

FIG. 4a shows a front view of a preferred embodiment of a HHCM, 10, when in use. The casing, 20, has a first casing, 20a, and a second casing, 20b, which are connected together by a tether, 56. The first casing, 20a, which contains the user-perceivable indicator, 22, is intended to be held in the user's hand, or to be placed nearby, while the second casing, 20b, is intended to be immersed in a cleaning solution, 58. The tether is preferably retractable and/or flexible, and may be formed of an insulated wire, an insulated pole, and/or other suitable material. The tether, 56, is also preferably waterproof, and should be of sufficient length so as to penetrate the suds layer, 60, if present. Thus, the tether is preferably from about 5 cm to about 1 m, more preferably from about 10 cm, to about 60 cm, and even more preferably from about 20 cm to about 45 cm in length. It is preferred that both the first casing, 20a, and the second casing, 20b, independently float in the cleaning solution, 58, if dropped or placed therein. However, it is also preferred that the second casing, 20b, float with the plurality of electrodes, 30, submerged in the cleaning solution, 58.

FIG. 4b shows a front view of the HHCM of FIG. 4a, except when not in use. In FIG. 4b, the tether is not shown, as it has retracted into the first casing, 20a.

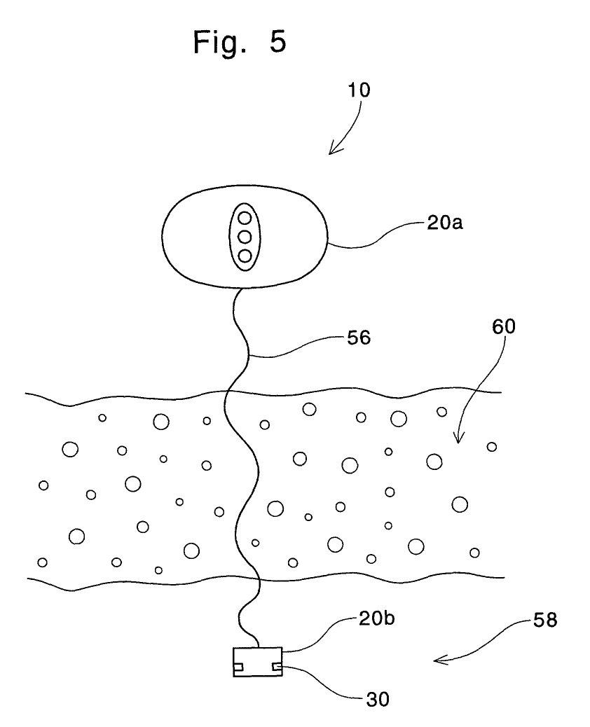

FIG. 5 shows a front view of a preferred embodiment of a HHCM, 10, when in use, where the first casing, 20a, is connected to the second casing, 20b, via a thin, wire-like tether, 56, which extends through the suds layer, 60, to the cleaning solution, 58. The second casing, 20b, contains a plurality of electrodes, 30, and does not float when placed in the cleaning solution, 58.

In a preferred embodiment, the HHCM is calibrated to the consumer product composition, the local water hardness, etc. via the internet. For example, by connecting the HHCM, either directly or indirectly to a web page on the internet which contains consumer product composition conductivity data, local water hardness data, etc. and downloading such data to the HHCM, and/or a memory module, and preferably a flash memory chip. In a preferred embodiment, the HHCM has a data jack, preferably an internal jack, and/or external water-resistant jack which allows the HHCM to be connected to a computer and/or directly to the internet in order to be updated. In another preferred embodiment, the HHCM has a data jack which does no require a physical connection, in order to update the data in the memory module. For example, an infrared data port, a wireless radio antenna, etc.

Method of Use

The present invention also provides a method for using a consumer product kit, and more preferably for measuring the conductivity of a cleaning solution. This method includes the steps of providing a HHCM having a user-perceivable indicator, adding a consumer product composition to water to form a consumer product solution, measuring the conductivity of the consumer product solution with the HHCM, and reading the user-perceivable indicator. Different consumer product compositions have different conductivities when at their respective acceptable concentrations and/or optimum concentrations. Thus, it is important that the HHCM be calibrated to the actual consumer product composition with which it is to be used.

The HHCM may be calibrated to the consumer product composition by, for example, storing the acceptable conductivity range within a memory module of FIG. 2, adjusting the resistances of the resistors in FIG. 3, etc. Other methods of calibrating the HHCM for the consumer product composition are also useful herein. In a preferred embodiment, and especially for a durable HHCM, the HHCM may be calibrated for a plurality of consumer product compositions, and/or be able to be updated by, for example, providing new conductivity information via downloading update information from the internet. New conductivity information may be also provided by replacing the memory module, adding a resistor, removing a resistor, replacing a resistor, etc. These updating methods may also be used to provide any other relevant data to the HHCM, such as water hardness data, temperature adjustment data, etc.

In cases where the consumer product concentration does not have the desired conductivity according to the user-perceivable indicator, the method herein also contains the optional steps of adjusting the weight ratio of consumer product composition to water, i.e., by adding more consumer product composition or more water to respectively raise or lower the consumer product concentration. The user may then re-measure the conductivity of the cleaning solution, and repeat these steps, as necessary, to achieve the desired consumer product concentration; e.g., until the acceptable concentration indicator, if present, is activated.

In a preferred embodiment of the present method, the water and consumer product composition, preferably a cleaning composition, are agitated by, for example, stirring, to ensure substantially complete dissolving of the consumer product composition, prior to measuring the conductivity of the consumer product solution. More preferably, the consumer product solution is mixed to homogeneity, prior to measuring the conductivity thereof. This preferred step helps to insure that the conductivity measurement is accurate, and reduces the chance that the HHCM is placed in an abnormal and/or transient region of relatively high or low conductivity. If additional consumer product composition or water is added, then it is also preferred that the consumer product solution again be agitated, and preferably homogenized, prior to re-measuring the conductivity.

If the consumer product composition is a cleaning composition, then the items to be cleaned are then washed in the cleaning solution, soaking them in the cleaning solution, scrubbing them with the cleaning solution, etc. While the HHCM may be used continuously during, for example, a cleaning process, it is preferred that the HHCM be used primarily during the preparation of the cleaning solution, and not while the items to be cleaned are actually immersed, and/or placed in the cleaning solution. This method of use avoids complications caused by changes in conductivity caused by the items to be cleaned, the soils thereupon, etc.

In a preferred embodiment of the present invention, the HHCM is designed to measure an additional factor in the consumer product solution, preferably an additional factor which changes over time, or during use of the p consumer product solution. The additional factor may be, for example, the bleach level, the turbidity/clarity of the consumer product solution, etc. For example, the oxygen bleach level of a cleaning solution may be measured in addition to the conductivity level. During the first conductivity measurement, the HHCM would act as previously described, and additionally double-check that the oxygen bleach level is also acceptable. In cases where the additional factor level is insufficient, even though the conductivity is acceptable (e.g., where the cleaning solution has already been used, where the cleaning solution has been prepared for a long time, etc.), the HHCM's processor may then adjust the user-perceivable indicator to indicate that more cleaning composition should be added to the cleaning solution. This allows the user to re-use the same cleaning solution for cleaning multiple items, and/or multiple loads, while still achieving the optimum concentration of the cleaning composition. Such a HHCM can significantly reduce water consumption by the consumer, and thereby save natural resources and money.

Examples of the invention are set forth hereinafter by way of illustration and are not intended to be in any way limiting of the invention.

### EXAMPLE 1

The HHCM of FIG. 1 is formed with a waterproof opaque plastic casing. The HHCM floats when placed in water/cleaning solution, with five LED indicators showing above the water/detergent solution level. A red low concentration indicator, three green acceptable concentration indicators, and a red high concentration indicator are present, and are arranged in a vertical line. The bottom green acceptable concentration indicator is labeled “lightly soiled clothing or delicates ”. The middle green acceptable concentration indicator is labeled “regularly soiled clothing ”. The top green acceptable concentration indicator is labeled “heavily soiled clothing ”.

The HHCM casing is formed of two hollow plastic pieces which are held together by two screws. A water-tight. resealable rubber seal prevents water/cleaning solution from entering the casing when the two screws are tightened. The HHCM has four electrodes which are arranged distal from the LEDs, and which rest below the water/detergent solution level, when the HHCM is floating. The four electrodes are coated with a plastic laminate to prevent corrosion and the build-up of contamination. The length is 15 cm, the width is 4 cm, and the height is 4 cm. The HHCM weighs 50 g.

Except as noted below, the electronics of FIG. 2 are included within the HHCM. The processor, hard-wired memory module, bandgap, oscillator, ADC, and temperature measuring circuit are all formed on a single ASIC. The HHCM is a durable HHCM, in which the lithium battery may be recharged by placing the HHCM in a cradle-like induction-type recharger. Thus, the HHCM requires no external recharging contacts.

A waterproof on/off button (not shown in the figures) is also included in the HHCM to conserve energy during extended periods of non-use. During use, the HHCM measures the conductivity 10 times per second, and averages 5 consecutive measurements to achieve an average conductivity measurement. Every 0.5 seconds, the processor compensates for the water/detergent solution temperature and water hardness, and calculates an average compensated conductivity measurement. The processor then compares this average compensated conductivity measurement with the ranges stored in the memory module, and lights the appropriate LED signal.

The HHCM is calibrated to a granular laundry detergent composition having the following formula:

| Ingredient | Weight % |
|---|---|
| Linear alkyl benzene sulfonate, sodium salt | 18 |
| Dimethyl hydroxyethyl quaternary ammonium | 0.6 |
| compound, chloride salt | |
| Alkyl ethoxylate sulfate, sodium salt | 0.8 |
| Sodium tripolyphosphate | 21 |
| Sodium silicate | 7 |
| Sodium carbonate | 13 |
| Nonionic polymers | 1.3 |
| Sodium perborate monohydrate | 3.6 |
| Sodium nonanoyloxybenzene sulfonate | 0.8 |
| Diethylene triamine pentaacetic acid | 0.6 |
| Disulfonate brightener, sodium salt | 0.06 |
| Minors (filler, enzyme, perfume, etc.) | balance |

The HHCM is calibrated according to the table below:

| | conductivity range |
|---|---|
| User-Perceivable LED Indicator | (mS/cm)* |
| low concentration | <2 |
| lightly-soiled/delicates | 2-3 |
| regularly-soiled | 3-3.5 |
| heavily-soiled | 3.5-5 |
| high concentration | >5 |

* mS/cm = milliSiemen/cm

In order to account for local water hardness, the HHCM has an additional button (not shown in the figures) which is pressed, while the electrodes are immersed in water, and prior to the addition of detergent composition to the water. When this is done, the HHCM measures the conductivity 10 times per second, and averages 5 consecutive measurements to achieve an average baseline conductivity measurement. During use, the HHCM then automatically subtracts the average baseline conductivity measurement from the average measured conductivity to arrive 10 at the average compensated conductivity measurement.

The HHCM is packaged together in a kit, along with the laundry detergent formulation, above, and the cradle-like induction-type recharger. When the detergent solution is dissolved in water to form a detergent solution, the HHCM is used to measure the conductivity, and the concentration of detergent composition is adjusted until the regularly-soiled LED indicator is lit.

### EXAMPLE 2

The kit of Example 1 has a HHCM as described, except that the HHCM contains a flash-memory chip connected to an internal universal serial bus (USB) port. To update the HHCM, the two screws are loosened, and the plastic casing is opened to reveal the USB port. One end of a computer cable is plugged into the USB port, and the other end is plugged into a personal computer. The personal computer accesses a web page via the internet, and then downloads detergent concentration information, local water hardness information, and temperature information into the flash-memory chip. The computer cable is then removed, and the casing sealed before use.

### EXAMPLE 3

A low-cost, disposable HHCM is formed according to the circuit diagram of FIG. 3, in a credit-card like shaped casing. Fifteen HHCMs are sold with a detergent composition to which they are calibrated. Each HHCM has a shelf-life of 180 days, and a working-life of 1 day. To conserve energy during use, the LEDs are designed to flash intermittently, rather than to light continuously. When a detergent solution is formed and the electrodes are immersed therein, the acceptable concentration indicator is lit.

### EXAMPLE 4

The kit of Example 2 has a HHCM as described, except that the internal USB is replaced with an infrared data port which allows the flash memory chip to be updated without opening the casing.

What is claimed is:

1. A kit for providing improved cleaning comprising:
A. a consumer product composition; and
B. a hand-held conductivity meter calibrated to the consumer product composition, wherein the hand-held conductivity meter comprises a user-perceivable indicator:

2. The kit of claim 1, wherein the consumer product composition is a cleaning composition selected from the group consisting of a hard surface cleaning composition, a laundry detergent composition, a personal cleansing composition, a bleach composition, a fabric rinse composition, and a combination thereof.

3. The kit of claim 1, wherein the hand-held conductivity meter is a disposable hand-held conductivity meter.

4. The kit of claim 1, wherein the user-perceivable indicator comprises an acceptable concentration indicator.

5. The kit of claim 1, wherein the hand-held conductivity meter is further calibrated to local water hardness conditions and to water temperature.

6. The kit of claim 4, wherein the hand-held conductivity meter further comprises a low concentration indicator and a high concentration indicator.

7. A method for measuring the conductivity of a consumer product solution comprising the steps of:
A. providing a hand-held conductivity meter calibrated to a consumer product composition, wherein the hand-held conductivity meter comprises a user-perceivable indicator;
B. adding the consumer product composition to water to form a consumer product solution;
C. measuring the conductivity of the consumer product solution with the hand-held conductivity meter; and
D. reading the user-perceivable indicator.

8. The method of claim 7 wherein the user-perceivable indicator comprises an acceptable concentration indicator and wherein the method further comprises adjusting the weight ratio of consumer product composition to water, where the adjusting step, the measuring step, and the reading step are repeated until the acceptable concentration indicator is activated.

9. The method of claim 7, wherein the consumer product composition is a cleaning composition, and wherein the user-perceivable indicator comprises an acceptable concentration indicator, a low concentration indicator, and a high concentration indicator.

10. The method of claim 7, further comprising the step of calibrating the hand-held conductivity meter via the internet.
